(19) United States
(12) Patent Application Publication
(10) Pub. No.: US 2026/0300948 A1
(43) Pub. Date: Oct. 1, 2026

(54) INFORMATION PROCESSING SYSTEM, INFORMATION PROCESSING METHOD, INFORMATION PROCESSING DEVICE, AND PROGRAM

(71) Applicant: JINS HOLDINGS Inc., Maebashi-shi (JP)

(72) Inventors: Reina KUROO, Maebashi-shi (JP); Nicholas Pak Sun CHIEN, Maebashi-shi (JP); Shinichiro MATSUDA, Maebashi-shi (JP); Ryo TANAKA, Maebashi-shi (JP)

(73) Assignee: JINS HOLDINGS Inc., Maebashi-shi (JP)

(21) Appl. No.: 19/578,197

(22) Filed: Mar. 25, 2026

(30) Foreign Application Priority Data
Mar. 31, 2025 (JP) 2025-057742

(51) Int. Cl. G06Q 20/20

(52) U.S. Cl. CPC G06Q 20/202; G06Q 20/208

(57) ABSTRACT

An information processing system to provide information to a customer in relation to purchase of eyewear. The system includes a customer terminal having a reception unit that receives input of purchase request information relating to the purchase and a purchase request information transmission unit that transmits the purchase request information to a server device. The server device having a purchase request information reception unit that receives the purchase request information a response information output unit that outputs response information indicating a response to the purchase request information by inputting the received purchase request information into a customer service model generated by machine learning using training data including arbitrary purchase request information and response information relating to the purchase. A response information transmission unit transmits the response information to the customer terminal having a response information reception unit that receives the response information and outputs the received response information.

### BACKGROUND

### Field

The present invention relates to an information processing system, an information processing method, an information processing device, and a program.

### Description of Related Art

Many techniques related to product purchases by users have been developed in the prior art. For example, Patent Publication JP-A-2017-54312 discloses a technique in which information about a product or the like is provided to a user by an information provision system constituted by an information acquisition device having a short-range wireless communication function, an information provision server, a user terminal, a display device, a store terminal, and so on.

### CITATION LIST

### Patent Literature

Patent Literature 1: Patent Publication JP-A-2017-54312

### SUMMARY

However, customer interests and preferences are becoming more diverse, leading to demand for personalized information and suggestions relating to products. This tendency is particularly evident in fields such as eyewear, in which suitable products vary widely depending on the facial features and preferences of the customer, and in many cases, it is impossible to respond sufficiently merely by providing conventional, standardized information.

Therefore, an object of the present invention is to provide an information processing system or the like with which it is possible to provide more suitable information to a customer in relation to the purchase of eyewear.

An information processing system according to an aspect of the present invention includes a customer terminal used by a customer, and a server device, the customer terminal having a reception unit that receives input of purchase request information relating to purchase of eyewear, and a purchase request information transmission unit that transmits the purchase request information to the server device, the server device having a purchase request information reception unit that receives the purchase request information from the customer terminal, a response information output unit that outputs response information indicating a response to the purchase request information by inputting the received purchase request information into a customer service model generated by machine learning using training data including arbitrary purchase request information and response information relating to the purchase of the eyewear, and a response information transmission unit that transmits the response information to the customer terminal, and the customer terminal further having a response information reception unit that receives the response information from the server device, and a response information output unit that outputs the received response information.

According to this aspect, the response information output in response to the input of purchase request information relating to the purchase of eyewear can be presented to the customer by the customer service model generated by machine learning, and as a result, it is possible to provide information that is more suitable for the customer in relation to the purchase of eyewear.

According to the present invention, it is possible to provide an information processing system or the like with which it is possible to provide more suitable information to a customer in relation to the purchase of eyewear.

### BRIEF DESCRIPTION OF DRAWINGS

FIG. 1 is a schematic view showing an example configuration of an information processing system 1 according to an embodiment;

FIG. 2 is a view showing an example hardware configuration of a computer 400 according to the present embodiment;

FIG. 3 is a schematic view showing an example functional configuration of a server device 10 according to the present embodiment;

FIG. 4A is a schematic view showing an example data structure of personal information 122;

FIG. 4B is a schematic view showing an example data structure of a purchase history 123;

FIG. 4C is a schematic view showing an example data structure of a conversation history 124;

FIG. 5 is a schematic view showing an example functional configuration of a customer terminal 20 according to the present embodiment;

FIG. 6 is a schematic view showing an example functional configuration of an employee terminal 30 according to the present embodiment;

FIG. 7 is a sequence diagram showing an example of operation processing performed by the information processing system 1 according to the present embodiment;

FIG. 8 is a view showing an example of a conversation screen 100 according to the present embodiment;

FIG. 9 is a sequence diagram showing an example of operation processing performed by the information processing system 1 according to the present embodiment;

FIG. 10 is a view showing an example of a code display screen 200 according to the present embodiment; and

FIG. 11 is a schematic view showing an example of a customer information display screen 300 according to the present embodiment.

### DETAILED DESCRIPTION

A preferred embodiment of the present invention will be described with reference to the attached figures. Note that in the figures, identical reference numerals denote identical or similar configurations. Moreover, the embodiments in the present disclosure are not limited to Japanese and may be applied to another language such as English or Chinese.

### (1) Overall Configuration of Information Processing System 1

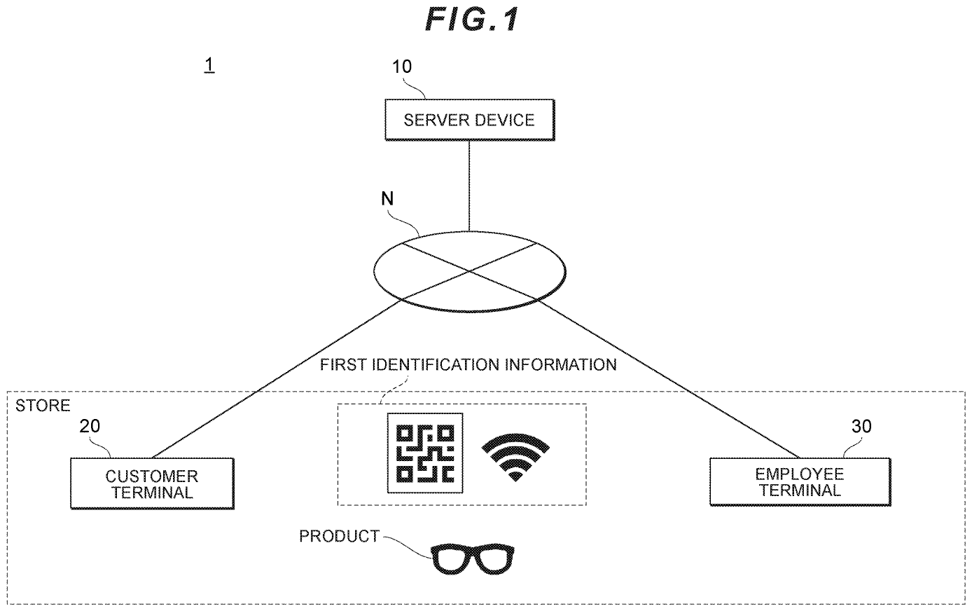

FIG. 1 is a schematic view showing an example configuration of an information processing system 1 according to the present embodiment. The information processing system 1 includes, for example, a server device 10, a customer terminal 20, and an employee terminal 30. The customer terminal 20 is an information processing device operated by a customer when purchasing a product or the like. The employee terminal 30 is an information processing device operated by an employee of an physical store or an online store (a virtual online store at which electronic commerce takes place). The physical store may include any product-related space, such as an information desk, as well as the location where the products (eyewear) are actually sold.

The server device 10, the customer terminal 20, and the employee terminal 30 are connected via a communication network N such as the Internet, for example. Further, the customer terminal 20 and the employee terminal 30 may be configured such that short-range wireless communication can be performed therebetween. Various communication standards, such as Bluetooth (registered trademark), RF-ID, DSRC (registered trademark), NFC, UWB, and ZigBee (registered trademark), can be applied as types of short-range wireless communication, but the short-range wireless communication is not limited thereto.

The server device 10 manages information about products, customers, etc., and provides the information about products, customers, etc. to the customer terminal 20 and/or the employee terminal 30. The server device 10 provides services related to product purchases by customers at an physical store or an online store. For example, the server device 10 acquires response information to purchase request information (text, voice, an image, or the like) transmitted from the customer terminal 20 by inputting the purchase request information into a customer service model, and transmits the acquired response information to the customer terminal 20.

### (2) Hardware Configuration

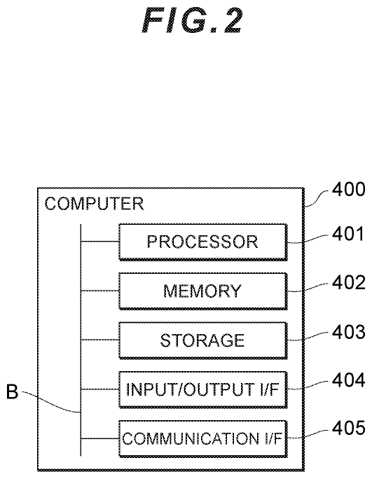

FIG. 2 is a view showing an example hardware configuration of a computer 400 according to the present embodiment. The server device 10, customer terminal 20, and employee terminal 30 according to this embodiment are each constituted by one or a plurality of computers 400, for example. Specifically, the computer 400 is envisaged as being a server device, a personal computer (PC), a personal digital assistant (PDA), a mobile information terminal such as a smartphone or a tablet terminal, a mobile telephone, or the like, but is not limited thereto.

The computer 400 includes a processor 401, a memory 402, a storage 403, an input/output interface (input/output I/F) 404, and a communication interface (communication I/F) 405. The respective constituent elements of the hardware of the computer 400 are connected to each other via a bus B, for example. The computer 400 realizes functions and/or methods pertaining to the present embodiment through cooperation between the processor 401, the memory 402, the storage 403, the input/output I/F 404, and the communication I/F 405.

The processor 401 executes functions and/or methods that are realized by codes or commands included in a program stored in the storage 403. The processor 401 may include, for example, a central processing unit (CPU), a micro processing unit (MPU), a graphics processing unit (GPU), a microprocessor, a processor core, a multiprocessor, an application-specific integrated circuit (ASIC), a field programmable gate array (FPGA), or the like, and may realize various processing pertaining to this embodiment using logic circuits (hardware) and dedicated circuits formed in an integrated circuit (IC) chip, large scale integration (LSI), or the like.

The memory 402 temporarily stores the program loaded from the storage 403 and provides the processor 401 with a working area. The memory 402 also temporarily stores various data generated while processor 401 executes of the program. The memory 402 includes, for example, a random access memory (RAM), a read only memory (ROM), or the like.

The storage 403 stores the program, for example. The storage 403 includes, for example, a hard disk drive (HDD), a solid state drive (SSD), a flash memory, or the like.

The input/output I/F 404 includes an input device into which various information relating to the computer 400 is input, and an output device that outputs processing results of processing performed by the computer 400. In the input/output I/F 404, the input device and the output device may be integrated or provided separately.

The input device receives input from an operator and provides information relating to the input to the processor 401. The input device may include, for example, an operation input device, such as a touch panel, a touch display, hardware keys on a keyboard or the like, or a pointing device such as a mouse, an image input device such as a camera, and a voice input device such as a microphone.

The output device outputs processing results of processing performed by the processor 401. The output device may include, for example, a display device that can display images (including moving images) in accordance with display data (screen information) serving as a processing result of the processing performed by the processor 401. The display device may include, for example, a touch panel, a touch display, a monitor (for example, a liquid crystal display, an organic electroluminescence display (OELD), or the like), a head mounted display (HMD), projection mapping, a hologram, or the like. The display device may also include, for example, a voice output device that can output voice in accordance with voice data serving as a processing result of the processing performed by the processor 401. The voice output device may include, for example, a speaker or the like. The output device may also include, for example, a print output device that outputs a print medium such as paper by printing, for example.

The communication I/F 405 transmits and receives various data to and from another information processing device or the like via the communication network N. This communication may be executed either by wire or wirelessly (including short-range wireless communication), and as long as mutual communication can be executed, any communication protocol may be used. The communication I/F 405 has a function for executing communication with another information processing device or machine via the communication network N. The communication I/F 405 transmits various data to the other information processing device in response to an instruction from the processor 401. Further, the communication I/F 405 receives various data transmitted from the other information processing device or machine, and supplies the received data to the processor 401.

The program of the present embodiment may be provided in a state of being stored on a computer-readable storage medium. The storage medium is capable of storing the program on a “non-temporary tangible medium”. The program includes a software program or a computer program, for example. The storage medium can include, as appropriate, one or a plurality of semiconductor-based media, or another integrated circuit (IC) (for example, a field programmable gate array (FPGA), an application-specific IC (ASIC), or the like), a hard disk drive (HDD), a hybrid hard drive (HHD), an optical disk, an optical disk drive (ODD), a magneto-optical disk, a magneto-optical drive, a floppy (registered trademark) diskette, a floppy (registered trademark) disk drive (FDD), magnetic tape, a solid-state drive (SSD), a RAM drive, a secure digital card or drive, any other appropriate storage medium, or an appropriate combination of two or more thereof. The storage medium may be volatile, nonvolatile, or a combination of volatile and nonvolatile, as appropriate.

The program according to the present embodiment may be provided to the computer 400 via any communication network N that is capable of transmitting the program. Furthermore, in the present embodiment, the program may also be realized in the form of a data signal embedded in a carrier wave and embodied by electronic transmission. Note that the program according to the present embodiment may be realized using, for example, a script language such as ActionScript or JavaScript (registered trademark), an object-oriented programming language such as Objective-C or Java (registered trademark), a markup language such as HTML 5, or the like.

At least a part of the processing performed in the computer 400 may be realized by cloud computing constituted by one or a plurality of computers. At least a part of the processing performed in the computer 400 may be performed by another information processing device. In this case, at least a part of the processing performed by respective function units realized by the processor 401 may be performed by the other information processing device.

### (3) Functional Configuration of Each Device

### (3-1) Configuration of Server Device 10

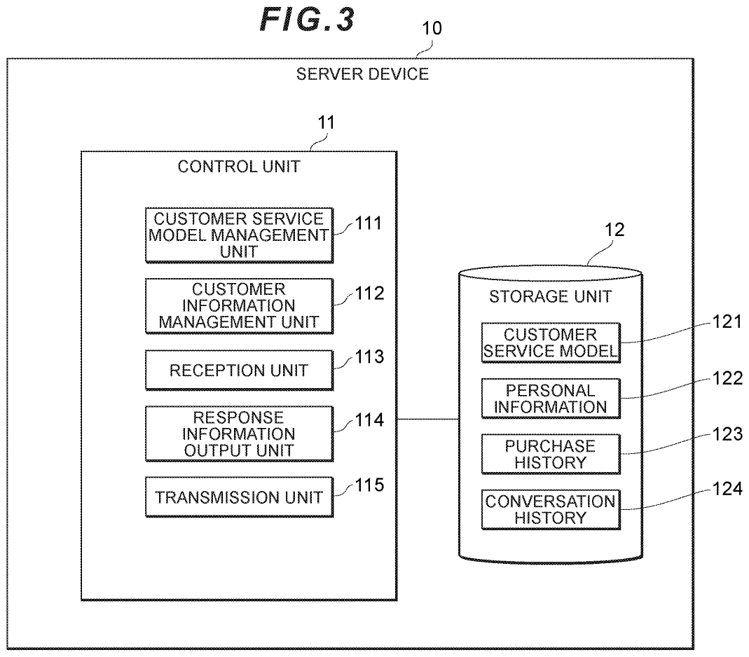

FIG. 3 is a schematic view showing an example functional configuration of the server device 10 according to the present embodiment. The server device 10 includes a control unit 11 and a storage unit 12. The control unit 11 includes a customer service model management unit 111, a customer information management unit 112, a reception unit 113, a response information output unit 114, and a transmission unit 115. The storage unit 12 includes a customer service model 121, personal information 122, a purchase history 123, and a conversation history 124.

The customer service model management unit 111 manages the customer service model 121 stored in the storage unit 12. The customer service model 121 may be, for example, an artificial intelligence (AI) model that performs customer service with respect to a customer who is considering purchasing a product, for example. In other words, the customer service model 121 may be a model that generates and provides response information such as information about products and recommendations on the basis of purchase request information (text, voice, an image, or the like) input by the customer.

Provided that the purchase request information is information relating to the purchase of a product, there are no particular limitations thereon, and the purchase request information may include, for example, a request for a basic description of the product, such as information about specifications, price, and inventory, a request for a product recommendation based on a comparison of a plurality of products, the preferences of the customer, eyewear usage scenarios, concerns about usage, and so on. The data format of the purchase request information is not limited to text and may be voice, an image, or a moving image.

Provided that the response information is information relating to the purchase of a product, there are no particular limitations thereon, and the response information may include, for example, a basic description of the product, such as information about specifications, price, and inventory, a product recommendation based on a comparison of a plurality of products or the preferences of the customer, and so on. The data format of the response information is not limited to text and may be voice, an image, or a moving image.

The customer service model management unit 111 may generate the customer service model 121 by executing machine learning using predetermined training data, for example. Training data constituted by a set of the purchase request information and the response information relating thereto may be used in the machine learning of the customer service model 121. The training data may include an actual customer service history such as a chat log, a voice interaction log, or an inquiry history of the online store or the physical store. The customer service model management unit 111 may additionally execute machine learning on the customer service model 121 using training data including, for example, the purchase request information received by the reception unit 113 and the response information output when the purchase request information is input into the customer service model 121.

There are no particular limitations on the machine learning method used to generate the customer service model 121. The machine learning method may include, for example, supervised learning using a neural network (deep learning), a support vector machine, a random forest, gradient boosting, or decision tree-based ensemble learning. The machine learning method may also include an approach using reinforcement learning, and may include a method in which the optimal response strategy is learned by causing an agent (AI) to attempt customer service and assigning a degree of customer satisfaction, a purchasing action, or the like as a reward. Furthermore, when a large-scale language model is used, a natural language generation method using a transformer-based model (GPT or the like) may be used. In the machine learning of the customer service model 121, example responses from a specific user (an employee with an excellent performance record or the like) may be included in the training data. By adding a history of interactions actually performed by the specific user, data obtained by virtually creating model customer service examples, and so on, it is possible to construct the customer service model 121 so as to incorporate the skills of personnel with excellent records. For example, the customer service model management unit 111 may generate the customer service model 121 by acquiring training data (including purchase request information and response information) associated with a specific user from a predetermined storage unit, and performing machine learning using the acquired training data.

The customer information management unit 112 manages customer information. The customer information may be, for example, information at least partially including the personal information 122, the purchase history 123, and the conversation history 124. For example, the customer information management unit 112 may acquire the desired customer information from the personal information 122, the purchase history 123, and the conversation history 124 in response to a request from the customer terminal 20 or the employee terminal 30, and supply the acquired information to the transmission unit 115.

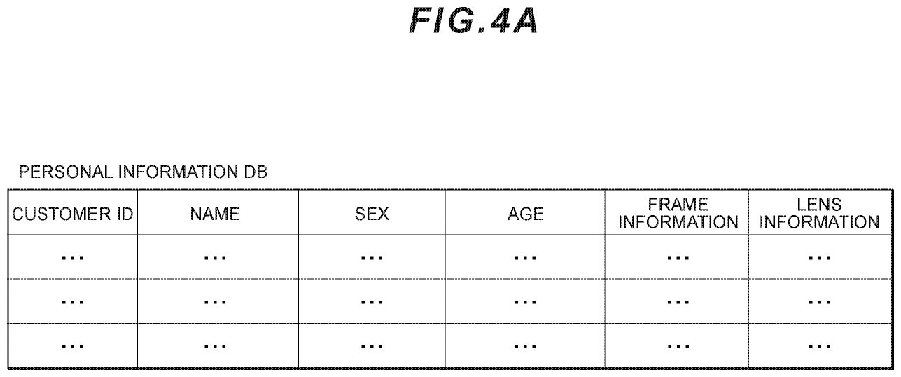

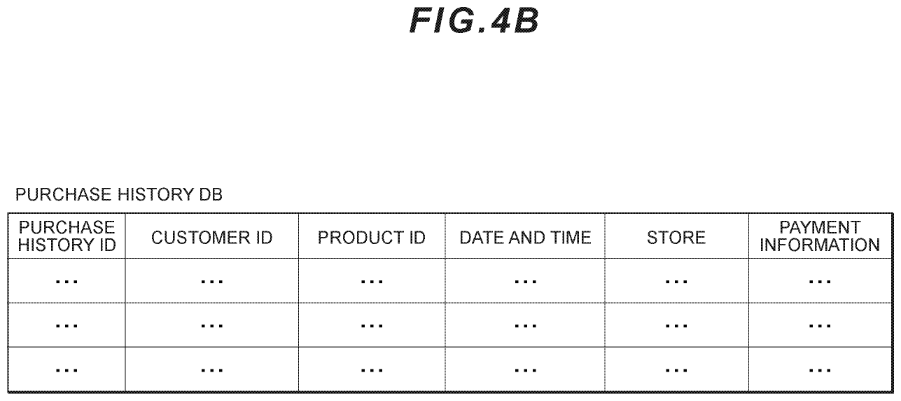

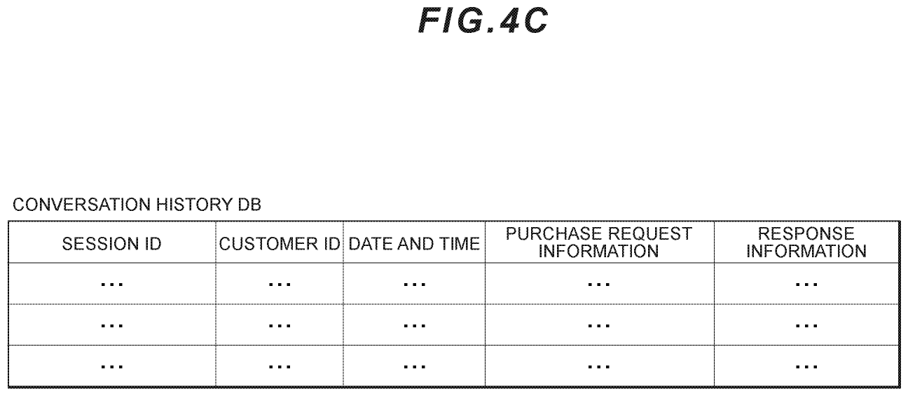

FIG. 4A is a schematic view showing an example data structure of the personal information 122. For example, as shown in FIG. 4A, “name”, “sex”, “age”, “frame information”, and “lens information” are registered in the personal information 122 in association with a “customer ID”. The “customer ID” is identification information for identifying a customer. The “name” is the name of the customer. The “sex” is information indicating the sex of the customer. The “age” is information in which the age of the customer is recorded. The “frame information” is information indicating the type or brand of a frame used or purchased by the customer. The “lens information” is information indicating the type or strength of lenses used or purchased by the customer.

FIG. 4B is a schematic view showing an example data structure of the purchase history 123. For example, “customer ID”, “product ID”, “date and time”, “store”, and “payment information” are registered in the purchase history 123 in association with a “purchase history ID”. The “purchase history ID” is unique identification information assigned to each purchase transaction. For example, the purchase history ID may be issued in response to an operation of a ticket issuing machine or the like at the physical store during a visit by the customer, or may be issued at the time of use of the online store. The “customer ID” is information for identifying the customer who has made the purchase, and is managed in conjunction with the personal information 122. The “product ID” is identification information of the product purchased by the customer. The “date and time” is information in which the date and time at which the purchase was made is recorded. The “store” is information in which the name and location of the physical store where the purchase was made or information about the online store is recorded. The “payment information” is information in which a payment method such as credit card or electronic payment account is recorded.

FIG. 4C is a schematic view showing an example data structure of the conversation history 124. Here, in the present embodiment, an interaction between the customer and the customer service model 121 in which the purchase request information is input and the response information is output may be referred to as a “conversation”. For example, “customer ID”, “date and time”, “purchase request information”, and “response information” are registered in the conversation history 124 in association with a “session ID”. The “session ID” is identification information for identifying the flow of a conversation. The “customer ID” is information for identifying the customer taking part in the conversation, and is managed in conjunction with the personal information 122. The “date and time” is information in which the date and time at which the conversation took place is recorded. The “purchase request information” is information in which the purchase request information input by the customer into the customer terminal 20 is recorded. The “response information” is information in which the response information provided by the customer service model 121 is recorded.

Returning to FIG. 3, the reception unit 113 receives various information from another information processing device such as the customer terminal 20 or the employee terminal 30. For example, the reception unit 113 may receive the purchase request information transmitted from the customer terminal 20. Further, for example, the reception unit 113 may receive an employee call request transmitted from the customer terminal 20.

The response information output unit 114 outputs response information indicating a response to the received purchase request information by inputting the purchase request information into the customer service model 121. The purchase request information may be received from the customer terminal 20, for example. The data format of the response information is not limited to text and may be voice, an image, or a moving image.

The transmission unit 115 transmits various information to another information processing device such as the customer terminal 20 or the employee terminal 30. For example, the transmission unit 115 may transmit the response information generated by the response information output unit 114 to the customer terminal 20. Further, for example, the transmission unit 115 may transmit an employee call notification to the employee terminal 30. Furthermore, for example, the transmission unit 115 may transmit customer information to the employee terminal 30.

### (3-2) Configuration of Customer Terminal 20

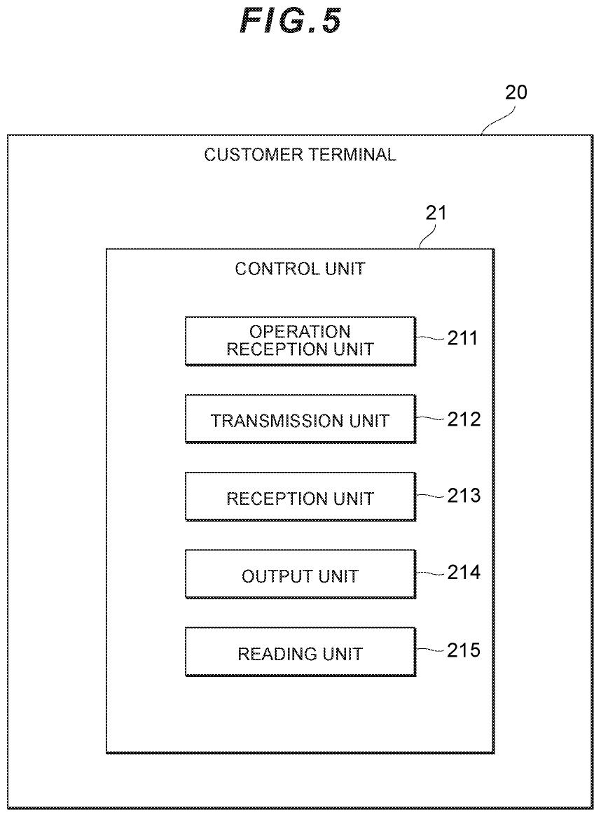

FIG. 5 is a schematic view showing an example functional configuration of the customer terminal 20 according to the present embodiment.

The customer terminal 20 is an information processing device operated by a customer when purchasing a product. For example, the customer terminal 20 may be a smartphone, a tablet terminal, a mobile telephone, a PDA, a PHS (Personal Handy-phone System), a laptop PC, or the like. Alternatively, the customer terminal 20 may be an information processing device such as a touch panel or a ticket issuing terminal installed in an physical store and used in common by a plurality of customers.

The customer terminal 20 includes a control unit 21. The control unit 21 performs overall control of respective units of the customer terminal 20. The control unit 21 includes an operation reception unit 211, a transmission unit 212, a reception unit 213, and output unit 214, and a reading unit 215.

The operation reception unit 211 receives customer operations. For example, the operation reception unit 211 may receive input of purchase request information relating to the purchase of a product. The purchase request information is information input into a chat screen or the like provided for the purpose of using the customer service model 121, and may take any form, such as text, voice, or an image. The operation reception unit 211 may also receive input of an employee call request, for example.

The transmission unit 212 transmits various information to another information processing device such as the server device 10 or the employee terminal 30. For example, the transmission unit 212 may transmit a call request to the server device 10. The transmission unit 212 may also transmit a request for customer information (the personal information, the purchase history, the conversation history, etc.) to the server device 10, for example.

The reception unit 213 receives various information from another information processing device such as the server device 10 or the employee terminal 30. For example, the reception unit 213 may receive the response information transmitted from the server device 10. The reception unit 213 may also receive identification information (an example of first identification information) for identifying a product in a store or the like, for example. The identification information may be provided in the form of a beacon transmitted from an arbitrary beacon transmitter by short-range wireless communication or the like. The reception unit 213 may also receive customer information (the personal information, the purchase history, the conversation history, etc.) from the server device 10, for example.

The output unit 214 outputs various information by controlling an output device installed in the customer terminal 20. For example, the output unit 214 may display an input screen for inputting the purchase request information. More specifically, the output unit 214 may display (activate) the purchase request information input screen in response to acquisition of the identification information for identifying the product.

The output unit 214 may also output identification information (an example of second identification information) for identifying the customer information (the personal information, the purchase history, the conversation history, etc.) so that the information can be acquired by the employee terminal 30, for example. There are no particular limitations on the second identification information, provided that the customer information can be identified therefrom, and for example, the second identification information may be the customer ID, the purchase history ID, the session ID, or the like. The employee terminal 30 can acquire the customer information (the personal information, the purchase history, the conversation history, etc.) by transmitting a request to the server device 10 on the basis of the second identification information acquired from the customer terminal 20. There are no particular limitations on the form in which the output unit 214 outputs the second identification information, provided that the second identification information can be acquired by the employee terminal 30, and for example, the second identification information may be a signal transmitted by short-range wireless communication or a code (a QR code or the like) displayed on a display device.

The output unit 214 may output the customer information (the personal information, the purchase history, the conversation history, etc.) acquired by the customer terminal 20 from the server device 10 in a form (a code such as a two-dimensional code, a short-range wireless communication signal, or the like) that allows the employee terminal 30 to acquire the information. There are no particular limitations on the form in which the output unit 214 outputs the customer information, provided that the customer information can be acquired by the employee terminal 30, and for example, the customer information may be a signal transmitted by short-range wireless communication or a code (a QR code or the like) displayed on a display device.

The reading unit 215 reads predetermined information via an image input device such as a camera installed in the customer terminal 20. For example, the reading unit 215 may read the identification information (an example of the first identification information) for identifying the product. The identification information may be provided in the form of a code such as a QR code disposed on or in the vicinity of a product in a store, an RFID tag such as an NFC, or the like. The reading unit 215 may acquire the identification information by reading the code, the RFID tag, or the like. The reading unit 215 may also acquire the identification information by performing image recognition processing (object recognition, a search, or the like) on an image obtained by photographing the product.

### (3-3) Configuration of Employee Terminal 30

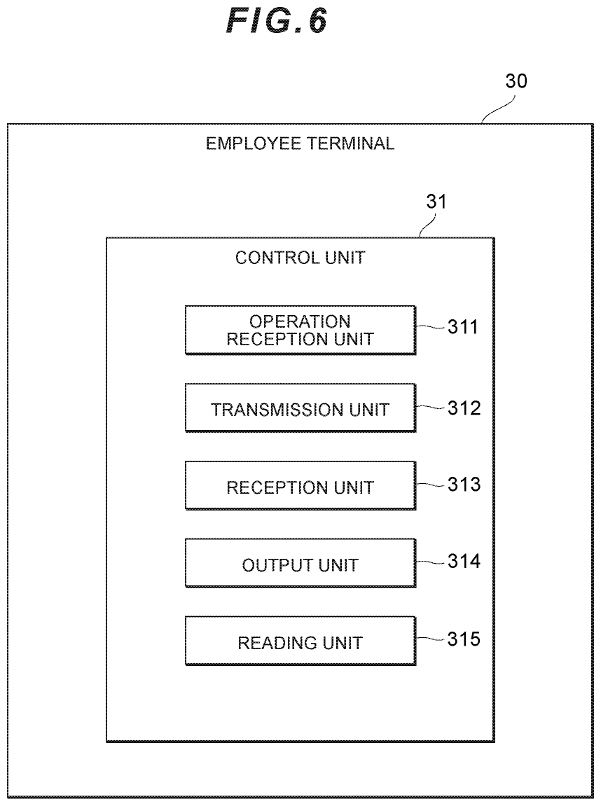

FIG. 6 is a schematic view showing an example functional configuration of the employee terminal 30 according to the present embodiment.

The employee terminal 30 is an information processing device operated by an employee who performs work such as customer service at an physical store or a virtual store. For example, the employee terminal 30 may be a smartphone, a tablet terminal, a mobile telephone, a laptop PC, a desktop PC, or the like. Further, the employee terminal 30 may be either an information processing device carried by an employee or an information processing device that is installed in an physical store and used in common by a plurality of employees. Furthermore, the employee terminal 30 is not limited to being carried by an employee, and may be a display device such as a display, a voice output device such as a speaker, or a print output device such as a printer used in common by a plurality of employees.

The employee terminal 30 includes a control unit 31. The control unit 31 includes an operation reception unit 311, a transmission unit 312, a reception unit 313, an output unit 314, and a reading unit 315.

The operation reception unit 311 receives operation input from an employee. For example, the operation reception unit 311 has a function for receiving operations such as checking purchase request information from a customer, searching for product information, and inputting recordings of customer service.

The transmission unit 312 transmits various information to another information processing device such as the server device 10 or the customer terminal 20. For example, the transmission unit 312 may transmit a request for customer information (the personal information, the purchase history, the conversation history, etc.) to the server device 10 or the customer terminal 20.

The reception unit 313 receives various information from another information processing device such as the server device 10 or the customer terminal 20. For example, the reception unit 313 may receive an employee call notification from the server device 10. Further, for example, the reception unit 313 may receive customer information (the personal information, the purchase history, the conversation history, etc.) from the server device 10.

The output unit 314 outputs various information by controlling an output device installed in the employee terminal 30. For example, the output unit 314 may output customer information and product information. Further, for example, the output unit 314 may output a call notification. For example, the output unit 314 may display the call notification as text data on a display device such as a display, or issue the call notification using a voice output device such as a speaker. Furthermore, the output unit 314 may output a medium on which the call notification has been printed from a print output device.

The reading unit 315 reads predetermined information via an image input device such as a camera installed in the employee terminal 30. For example, the reading unit 315 may read the identification information (an example of the first identification information) for identifying a product. The identification information may be provided in the form of a code such as a QR code disposed on or in the vicinity of a product in a store, an RFID tag such as an NFC, or the like. The reading unit 315 may acquire the identification information by reading the code, the RFID tag, or the like. The reading unit 315 may also acquire the identification information displayed on the customer terminal 20.

### (4) Operation Processing

### (4-1) Operation Processing Relating to Conversation Between Customer and Customer Service Model 121

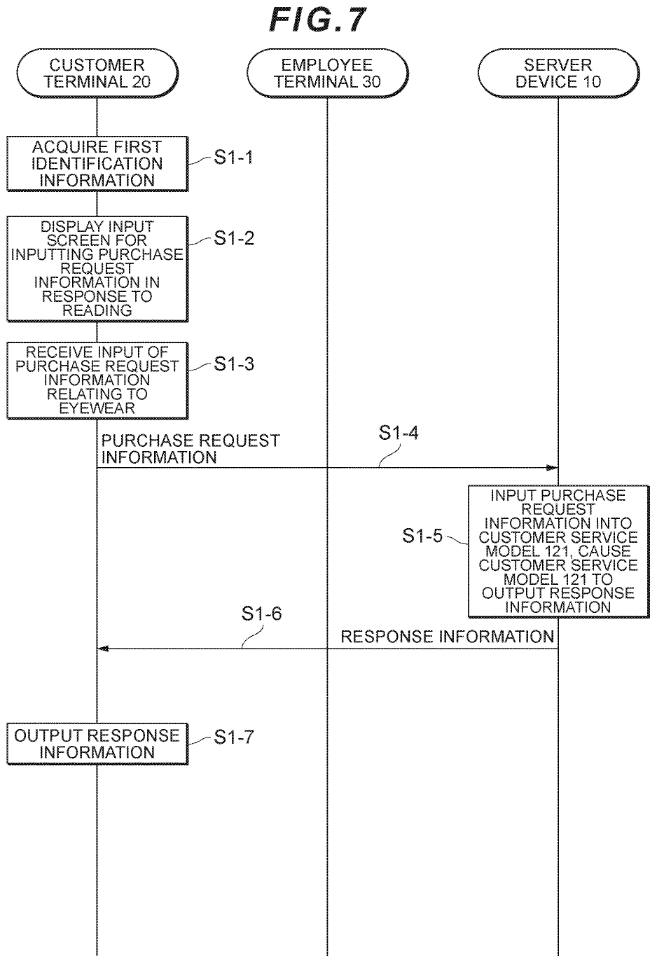

FIG. 7 is a sequence diagram showing an example of operation processing performed by the information processing system 1 according to the present embodiment. This operation processing relates to a conversation between the customer and the customer service model 121.

### S1-1

For example, the customer terminal 20 reads the identification information (an example of the first identification information) for identifying a product in response to a customer operation at an physical store. The identification information may be provided in the form of a code such as a QR code disposed on or in the vicinity of a product in a store, an RFID tag such as an NFC, or the like. Alternatively, the identification information may be acquired by image recognition processing (object recognition, a search, or the like) performed on an image obtained by the customer terminal 20 by photographing the product.

### S1-2

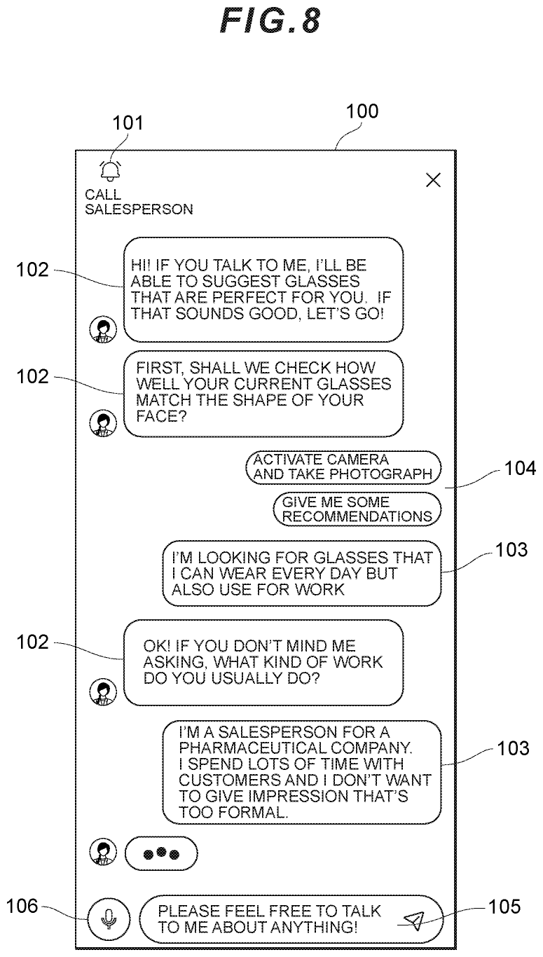

The customer terminal 20, having acquired the identification information for identifying the product, displays a conversation screen 100 shown in FIG. 8, for example. The conversation screen 100 is a screen on which the customer converses (inputs the purchase request information and checks the output response information) with the customer service model 121. Note that when an online store is used, S1-1 and S1-2 need not be executed. When an online store is used, the customer may display the conversation screen 100 by performing an arbitrary operation on the customer terminal 20, for example.

### S1-3

The customer terminal 20 receives input of the purchase request information in response to a customer operation on the conversation screen 100. The purchase request information may be in any format, such as text, voice, or an image. For example, the customer can input the purchase request information by inputting arbitrary text into a text input field 105 of the conversation screen 100 shown in FIG. 8. Further, for example, the customer can activate a voice input function by selecting a microphone icon 106 on the conversation screen 100, and input the purchase request information by speaking into the customer terminal 20. Furthermore, for example, the customer can input the purchase request information by selecting a function call-up button 104. For example, when the customer selects a text part such as “Activate the camera and take a photograph” among the function call-up buttons 104, image capture is performed by the input/output I/F 404 of the customer terminal 20, whereby the purchase request information can be input as an image. Furthermore, when the customer selects a text part such as “Give me some recommendations” among the function call-up buttons 104, purchase request information set as a default can be input. The content of the purchase request information input by the customer may be displayed in a speech bubble 103 on the conversation screen 100. Moreover, when the customer selects “Select from photos” (not shown) as the function call-up button 104, an image selected from stored images or the like can be input as the purchase request information.

### S1-4

The customer terminal 20 transmits the input purchase request information to the server device 10. The purchase request information may be in any format, such as text, voice, or an image, depending on the content input by the customer.

### S1-5

The server device 10 inputs the received purchase request information into the customer service model 121 and outputs response information from the customer service model 121. For example, the server device 10 may provide

personalized response information based on the preferences and purchase history of the customer using a customer service model that utilizes machine learning or natural language processing. The response information may include information about the specifications, price, and inventory of the product, suggestions of similar products, and so on. Note that the server device 10 may further execute machine learning on the customer service model 121 using training data including the purchase request information transmitted from the customer terminal 20 in S1-4 and the response information output in S1-5 in response to input of the purchase request information into the customer service model 121.

### S1-6

The server device 10 transmits the generated response information to the customer terminal 20. For example, the server device 10 may transmit the response information generated on the basis of the purchase request information in any format, such as text, voice, an image, or a moving image.

### S1-7

The customer terminal 20 outputs the received response information. For example, the customer terminal 20 may display or reproduce the response information on the conversation screen 100 shown in FIG. 8 in any format, such as text, voice, an image, or a moving image, and thus present the response information to the customer in an optimal form. A response information display portion 102 is a chat display area for presenting the response information generated by the server device 10. The response information display portion 102 may be an area for displaying the response information in a format such as text, voice, or an image.

S1-3 to S1-7, described above, may be executed repeatedly as desired. more specifically, the customer can repeatedly input purchase request information and check the response information output in response thereto until the desired response information is obtained. Thus, a product can be selected appropriately. Specifically, by checking the personalized response information generated by the customer service model 121, a more efficient and more accurate selection can be made.

### (4-2) Operation Processing Relating to Interlinking of Customer Service Model 121 and Employee

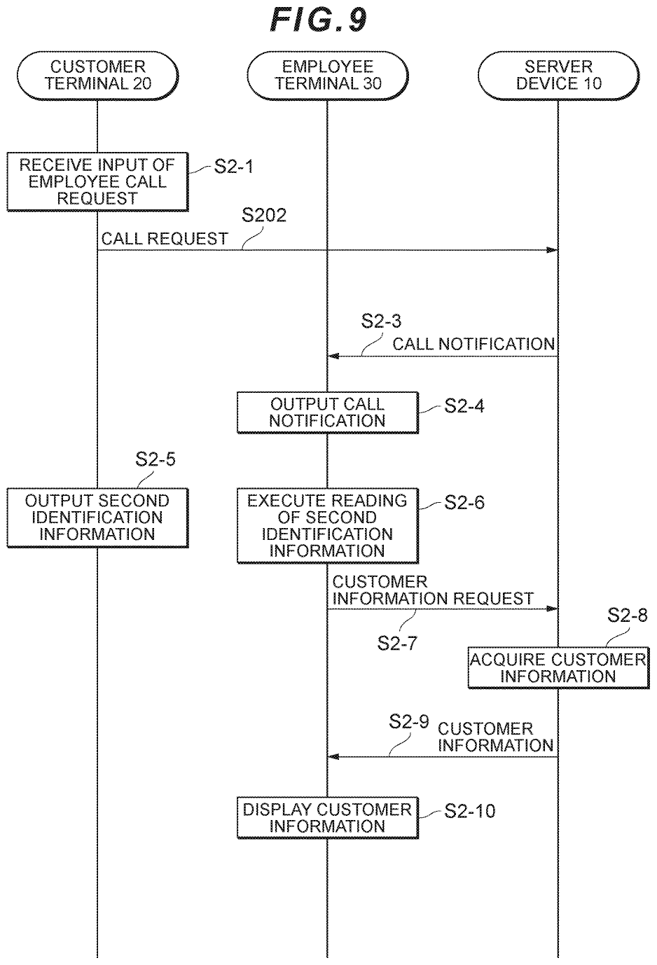

FIG. 9 is a sequence diagram showing an example of operation processing performed by the information processing system 1 according to the present embodiment. This operation processing relates to interlinking of the customer service model 121 and an employee, and may be executed after the operation processing shown in FIG. 7, for example.

### S2-1

The customer terminal 20 receives input of an employee call request. For example, the customer terminal 20 receives input of the call request in response to the customer selecting a call request icon 101 on the conversation screen 100 shown in FIG. 8. In the example of FIG. 8, the icon 101 includes a bell object and the text “Call a salesperson”, but the display mode of the call request icon is not limited to that shown in the figure.

### S2-2

The customer terminal 20 transmits the input call request to the server device 10.

### S2-3

The server device 10 transmits a call notification to the employee terminal 30 on the basis of the received call request. The server device 10 transmits the call notification to the employee terminal 30. The data format of the call notification is selected as appropriate in accordance with the configuration and output mode of the employee terminal 30. For example, when the notification is to be displayed on a display of the employee terminal 30, the call notification is transmitted as text data, and when the terminal is capable of issuing voice notifications, voice data is transmitted. Thus, the employee can quickly recognize the call request and respond appropriately.

### S2-4

The employee terminal 30 receives the call notification transmitted from the server device 10, and issues a notification as appropriate in accordance with the output mode thereof. For example, the employee terminal 30 may display the notification as text data on a display device such as a display, or issue a voice notification using a voice output device such as a speaker. The employee terminal 30 may also output a medium on which the call notification has been printed from a print output device. Thus, the employee can recognize the call request by an appropriate method and respond quickly.

Note that the call request (S2-2) may include identification information for identifying the customer information. The server device 10 may refer to the storage unit 12 and identify the customer information on the basis of the information included in the call request (S2-3), and then transmit the identified customer information to the employee terminal 30 together with the call notification (S2-3). The employee terminal 30 may output the customer information together with the received call notification (S2-4). Thus, the employee can ascertain the customer information and provide smooth customer service.

### S2-5

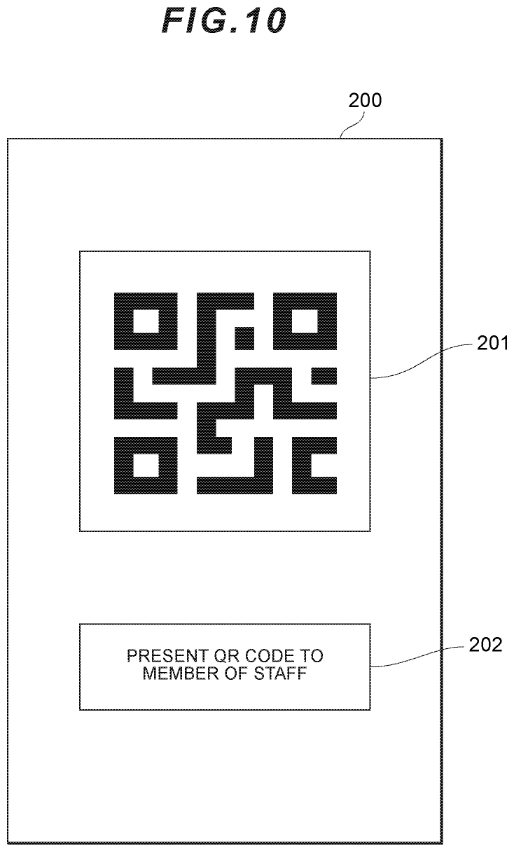

When the employee comes to the customer upon receiving the call notification, for example, the customer terminal 20 outputs the second identification information for identifying the customer information. For example, the customer terminal 20 may present the second identification information by displaying a QR code or the like on a screen, or may output the second identification information by short-range wireless communication. FIG. 10 is an example of a code display screen 200 displayed on the customer terminal 20 when the second identification information is displayed as a QR code. The display screen 200 may include a QR code 201 and guidance text 202 for the customer. The guidance text 202 may include guidance wording such as “Present the QR code to a member of staff”.

### S2-6

For example, the employee terminal 30 reads the code presented by the customer terminal 20 in response to an operation by the employee who has received the presented code displayed on the customer terminal 20 from the customer. For example, the employee terminal 30 may scan the code using a camera or a barcode reader installed in the employee terminal 30. Thus, the employee terminal 30 acquires the second identification information (the identification information for identifying the customer information). Note that the customer terminal 20 may also transmit the second identification information to the employee terminal 30 by short-range wireless communication.

### S2-7

The employee terminal 30 transmits a customer information request to the server device 10. For example, the customer information request may include the second identification information acquired by reading the code in S2-6.

### S2-8

The server device 10, upon receiving the customer information request, acquires the requested customer information from the storage unit 12 on the basis of the customer information request. For example, the server device 10 may acquire the personal information, the purchase history, the conversation history, etc. as the customer information.

### S2-9

The server device 10 transmits the acquired customer information to the employee terminal 30.

### S2-10

The employee terminal 30 displays the customer information received from the server device 10. For example, by displaying the purchase history of the customer as a list on the display, the employee can quickly perform optimal customer service.

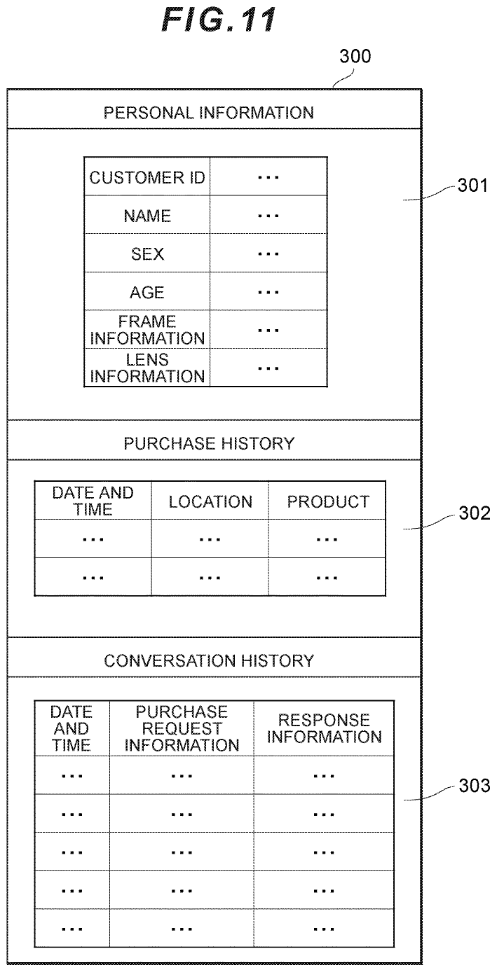

FIG. 11 is a schematic view showing an example of a customer information display screen 300 displayed on the employee terminal 30. The customer information display screen 300 may include, for example, a personal information display area 301, a purchase history display area 302, and a conversation history display area 303.

Information acquired from the personal information 122 stored in the storage unit 12 of the server device 10 may be displayed in the display area 301. Thus, the employee can immediately check the basic information of the customer and provide smooth customer service. Furthermore, by appropriately managing attribute information for each customer, product suggestions based on the purchase history and preferences can be provided.

Information acquired from the purchase history 123 stored in the storage unit 12 of the server device 10 may be displayed in the display area 302. Thus, the employee can immediately check the past purchase history of the customer and provide smooth customer service. Furthermore, by appropriately managing the purchase history of the customer, appropriate suggestions of products that are similar to products purchased in the past or relating to warranty support and aftercare services can be provided. As a result, the workload of the employee can be lightened and customer satisfaction can be improved.

Information acquired from the conversation history 124 stored in the storage unit 12 of the server device 10 may be displayed in the display area 303. Thus, the employee can immediately check the content of inquiries and interactions with the customer service model 121 (purchase request information, response information, etc.) conducted by the customer in the past and provide smooth customer service. Furthermore, by appropriately managing the conversation history for each customer, online inquiry content can be shared among stores, ensuring consistency in customer service. As a result, the customer can be relieved of the trouble of repeatedly describing the same information, and can thus enjoy a smoother purchasing experience. Moreover, by having the employee provide supplementary explanation of information relating to a product recommended by the customer service model 121, seamless customer service interlinking between AI (the customer service model 121) and a human can be achieved.

As a result of the above, the employee can quickly respond appropriately to each customer. Furthermore, since it is easy to refer to the past purchase history and inquiry history of the customer, personalized customer service can be provided. Moreover, by interlinking with the server device 10 in real time, the latest customer information can be acquired, and accurate guidance can be provided.

Note that in place of S2-5 to S2-10 described above, first, the customer terminal 20, having transmitted the purchase request information to the server device 10, may acquire the customer information from the server device 10 and output the acquired customer information in a form (a code such as a two-dimensional code, a short-range wireless communication signal, or the like) that allows the employee terminal 30 to acquire the information. The employee terminal 30 may acquire the customer information from the customer terminal 20. There are no particular limitations on the form in which the customer information is output, provided that the customer information can be acquired by the employee terminal 30, and for example, the customer information may be a signal transmitted by short-range wireless communication or a code (a QR code or the like) displayed on a display device.

### REFERENCE SIGNS LIST

1 Information processing system
10 Server device
11 Control unit
111 Customer service model management unit
112 Customer information management unit
113 Reception unit
114 Response information output unit
115 Transmission unit
12 Storage unit
121 Customer service model
122 Personal information
123 Purchase history
124 Conversation history
20 Customer terminal
21 Control unit
211 Operation reception unit
212 Transmission unit
213 Reception unit
214 Output unit
215 Reading unit
30 Employee terminal
31 Control unit
311 Operation reception unit
312 Transmission unit
313 Reception unit
314 Output unit
315 Reading unit
400 Computer
401 Processor
402 Memory
403 Storage
404 Input/output interface
405 Communication interface

What is claimed is:

1. An information processing system comprising a customer terminal used by a customer, and a server device,
the customer terminal including:
a reception unit that receives input of purchase request information relating to purchase of eyewear; and
a purchase request information transmission unit that transmits the purchase request information to the server device,
the server device including:
a purchase request information reception unit that receives the purchase request information from the customer terminal;
a response information output unit that outputs response information indicating a response to the purchase request information by inputting the received purchase request information into a customer service model generated by machine learning using training data including arbitrary purchase request information and response information relating to the purchase of the eyewear; and
a response information transmission unit that transmits the response information to the customer terminal, and
the customer terminal further including:
a response information reception unit that receives the response information from the server device; and
a response information output unit that outputs the received response information.

2. The information processing system according to claim 1, the customer terminal further comprising:
an acquisition unit that acquires first identification information for identifying a product; and
an input screen output unit that outputs an input screen for inputting the purchase request information on the basis of the first identification information.

3. The information processing system according to claim 1, wherein the customer service model is further subjected to machine learning using training data generated on the basis of a specific user.

4. The information processing system according to claim 1, wherein the customer service model is further subjected to machine learning using training data including the purchase request information received by the purchase request information reception unit and the response information output when the purchase request information is input into the customer service model.

5. The information processing system according to claim 1, the information processing system further comprising an employee terminal used by an employee of a store,
the customer terminal further including:
a call request reception unit that receives input of a call request for the employee; and
a call request transmission unit that transmits the call request to the server device,
the server device further including:
a call request reception unit that receives the call request from the customer terminal; and
a call notification transmission unit that transmits a call notification to the employee terminal on the basis of the call request, and
the employee terminal including:
a call notification reception unit that receives the call notification from the server device; and
a call notification output unit that outputs the call notification.

6. The information processing system according to claim 5, the server device further comprising:
a storage unit that stores customer information including the purchase request information and the response information in a predetermined storage portion in association with the customer;
a customer information acquisition unit that acquires the customer information from the predetermined storage portion in response to the call request; and
a customer information transmission unit that transmits the acquired customer information to the employee terminal.

7. The information processing system according to claim 1, the information processing system further comprising an employee terminal used by an employee of a store,
the server device further including:
a storage unit that stores customer information including the purchase request information and the response information in a predetermined storage portion in association with the customer;
a customer information request reception unit that receives a customer information request, which is a request for the customer information, from the customer terminal or the employee terminal;
a customer information acquisition unit that acquires the customer information from the predetermined storage portion in response to the customer information request; and
a customer information transmission unit that transmits the acquired customer information to the customer terminal or the employee terminal.

8. The information processing system according to claim 7, the customer terminal further comprising:
a customer information request transmission unit that transmits the customer information request to the server device;
a customer information reception unit that receives the customer information from the server device; and
a customer information output unit that outputs the received customer information, and
the employee terminal further including a customer information acquisition unit that acquires the customer information output by the customer information output unit.

9. The information processing system according to claim 8, wherein the customer information output unit displays a code from which the customer information can be read, and
the customer information acquisition unit acquires the customer information by reading the code.

10. The information processing system according to claim 7, the customer terminal further comprising a second identification information output unit that outputs second identification information for identifying the customer information, and
the employee terminal further including:
a second identification information acquisition unit that acquires the second identification information output by the second identification information output unit;
a customer information request transmission unit that transmits the customer information request including the second identification information to the server device; and
a customer information reception unit that receives the customer information from the server device.

11. The information processing system according to claim 10, wherein the second identification information output unit displays a code from which the second identification information can be acquired, and
the second identification information acquisition unit acquires the second identification information by reading the code.

12. An information processing method executed by an information processing system comprising a customer terminal used by a customer, and a server device,
the customer terminal executing:
receiving input of purchase request information relating to purchase of eyewear; and
transmitting the purchase request information to the server device,
the server device executing:
receiving the purchase request information from the customer terminal;
outputting response information indicating a response to the purchase request information by inputting the received purchase request information into a customer service model generated by machine learning using training data including arbitrary purchase request information and response information relating to the purchase of the eyewear; and
transmitting the response information to the customer terminal, and
the customer terminal further executing:
receiving the response information from the server device; and
outputting the received response information.

13. An information processing device comprising:
a purchase request information reception unit that receives purchase request information relating to purchase of eyewear from a customer terminal used by a customer;
a response information output unit that outputs response information indicating a response to the purchase request information by inputting the received purchase request information into a customer service model generated by machine learning using training data including arbitrary purchase request information and response information relating to the purchase of the eyewear; and
a response information transmission unit that transmits the response information to the customer terminal.

14. An information processing method in which an information processing device executes:
receiving purchase request information relating to purchase of eyewear from a customer terminal used by a customer;
outputting response information indicating a response to the purchase request information by inputting the received purchase request information into a customer service model generated by machine learning using training data including arbitrary purchase request information and response information relating to the purchase of the eyewear; and
transmitting the response information to the customer terminal.

15. A program for causing one or a plurality of computers to function as:
a purchase request information reception unit that receives purchase request information relating to purchase of eyewear from a customer terminal used by a customer;
a response information output unit that outputs response information indicating a response to the purchase request information by inputting the received purchase request information into a customer service model generated by machine learning using training data including arbitrary purchase request information and response information relating to the purchase of the eyewear; and
a response information transmission unit that transmits the response information to the customer terminal.
